(19) United States
(12) Patent Application Publication
(10) Pub. No.: US 2022/0277513 A1
(43) Pub. Date: Sep. 1, 2022

(54) METHOD FOR CONSTRUCTING A THREE-DIMENSIONAL MODEL USING TOMOGRAPHIC RECONSTRUCTION TECHNIQUE

(71) Applicant: National Tsing Hua University, Hsinchu City (TW)

(72) Inventors: Chien-Chun CHEN, Hsinchu City (TW); Ya-Ting CHANG, Hsinchu City (TW)

(73) Assignee: National Tsing Hua University, Hsinchu City (TW)

(21) Appl. No.: 17/186,135

(22) Filed: Feb. 26, 2021

(51) Int. Cl. G06T 17/00; G06T 19/20

(52) U.S. Cl. CPC G06T 17/00; G06T 19/20; G06T 2219/2004

(57) ABSTRACT

A method for constructing a three-dimensional (3D) model of an object includes: obtaining multiple 2D tomogram datasets of the object; constructing an initial 3D model; performing an iteration procedure that includes performing a spinning transformation on the initial 3D model so as to obtain a to-be-replaced (TBR) 3D model in a polar coordinate system of a 3D Fourier domain, performing a spatial transformation on one of the tomogram datasets to obtain a transformed dataset, replacing apart of the TBR 3D model using the transformed dataset, and repeating the above steps until each of the transformed datasets has been used to replace the TBR 3D model; and obtaining the 3D model of the object based on the iteration procedure.

### FIELD

The disclosure relates to a method for constructing a three-dimensional model of a to-be-inspected object, and more particularly to a method for constructing a three-dimensional model of a to-be-inspected object using tomographic reconstruction technique.

### BACKGROUND

Conventionally, the technology of tomography enables the imaging of the inside of an object. In use, the object may be subjected to a tomography scan by a tomograph (i.e., a device used to perform the tomography) so as to obtain a number of two-dimensional (2D) images of various sections of the object. The 2D images are then used to construct a three-dimensional model of the object for subsequent use (e.g., inspection). Such an operation may be referred to as tomography reconstruction, and may be useful in many fields such as wafer/metal defect inspection, semiconductor packaging, medical inspection, etc.

It is noted that the tomograph has a certain field of view (FoV) that may be smaller than a size of the object. In such a case, the information obtained by the 2D images of the sections of the object may not include all information of the object (e.g., information on an edge of the object may be missing), resulting in the 2D images not accurately reflecting the actual structure of the object. Alternatively, the 2D images may have incomplete representation, resulting in artifacts.

One way to resolve this issue is to place the object farther from the tomograph so as to keep the entire object within the FoV of the tomograph, so a number of 2D images each showing an entire section of the object can be obtained. However, the 2D images obtained in this way have lower resolution and less image detail. Alternatively, more tomography operations may be performed with respect to one specific plane relative to the object, so as to obtain a number of tomograms cooperatively constituting a larger sectional image of the object. In the case that only a part of the object is of interest, the object may be segmented so as to obtain said part of interest before subjecting the object to the tomography operation.

### SUMMARY

Therefore, one object of the disclosure is to provide a method that can alleviate at least one of the drawbacks of the prior art.

According to one embodiment of the disclosure, the method for constructing a three-dimensional (3D) model of a to-be-inspected object is provided. The method is implemented using a system that includes a tomograph and a computing device. The method includes steps of:
a) obtaining, by the tomograph, a plurality of tomograms associated with the to-be-inspected object, each of the tomograms being taken at a specific angular position with respect to an axis of the to-be-inspected object;
b) generating, by the computing device, a plurality of two-dimensional (2D) tomogram datasets related the to-be-inspected object based on the tomograms, each of the tomogram datasets being related to a respective one of the tomograms and including data of the respective one of the tomograms that shows a part of the to-be-inspected object in a polar coordinate system of a real domain;
c) constructing, by the processor, an initial 3D model in a Cartesian coordinate system of the real domain;
d) performing, by the processor, an iteration procedure that includes sub-steps of
   d-1) performing a spinning transformation on the initial 3D model, so as to obtain a to-be-replaced 3D model in a polar coordinate system of a 3D Fourier domain rotated by a spin angle with respect to the axis of the to-be-inspected object,
d-2) performing a spatial transformation on each of the 2D tomogram datasets, so as to obtain a plurality of transformed datasets that are obtained respectively from the 2D tomogram datasets and that are related respectively to a plurality of transformed images, the transformed images being in the polar coordinate system of the 3D Fourier domain and corresponding with the tomograms, respectively,
d-3) replacing, by the processor, a part of the to-be-replaced 3D model with one of the transformed images in the polar coordinate system of the 3D Fourier domain using a corresponding one of the transformed datasets, and
d-4) repeating sub-steps d-1) to d-3) with the to-be-replaced 3D model obtained in a previous execution of sub-step d-3) serving as the initial 3D model to be processed in a current execution of sub-step d-1) until each of the transformed images has been used to replace the to-be-replaced 3D model; and
e) obtaining, by the processor, the 3D model of the to-be-inspected object in the Cartesian coordinate system of the real domain based on a result of the to-be-iterated procedure.

### BRIEF DESCRIPTION OF THE DRAWINGS

Other features and advantages of the disclosure will become apparent in the following detailed description of the embodiments with reference to the accompanying drawings, of which:

FIG. 1 is a system for implementing a method for constructing a three-dimensional model of a to-be-inspected object according to one embodiment of the disclosure;

FIG. 2 is a flow chart illustrating steps of a method for constructing a three-dimensional model of a to-be-inspected object according to one embodiment of the disclosure;

FIG. 3 is a schematic front view of an exemplary to-be-inspected object;

FIG. 4 illustrates a number of exemplary tomograms obtained for the to-be-inspected object;

FIG. 5 is a flow chart illustrating sub-steps of an iteration procedure according to one embodiment of the disclosure;

FIG. 6 illustrates a two-dimensional shear transformation;

FIG. 7 illustrates five exemplary transformed images to be used to replace a to-be-replaced 3D model;

FIG. 8 illustrates an image of a resulting 3D model of the to-be-inspected object; and FIG. 9 is a schematic perspective view of a part of the 3D model of the to-be-inspected object;

FIG. 10 illustrates an example where only a part of the initial 3D model is subjected to the iteration procedure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics. Throughout the disclosure, the term “coupled to” may refer to a direct connection among a plurality of electrical apparatus/devices/equipments via an electrically conductive material (e.g., an electrical wire), or an indirect connection between two electrical apparatus/devices/equipments via another one or more apparatus/device/equipment, or wireless communication.

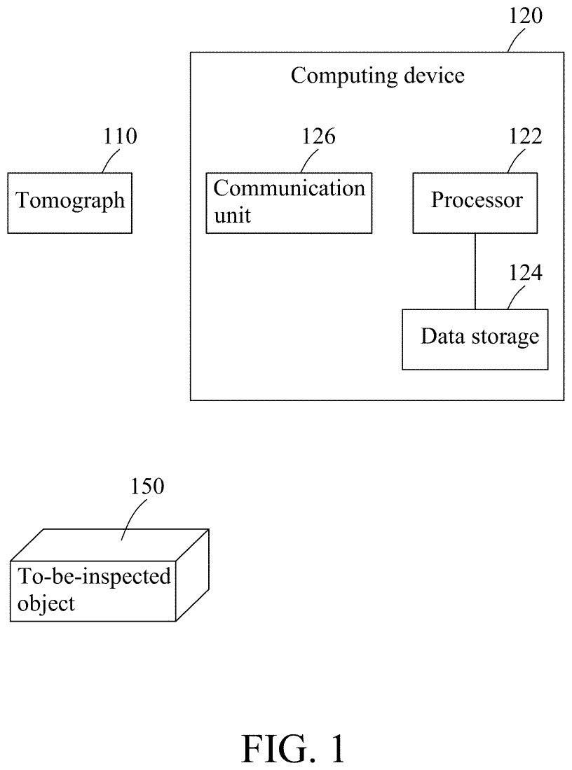

FIG. 1 is a block diagram illustrating a system 100 for implementing a method for constructing a three-dimensional model of a to-be-inspected object 150 according to one embodiment of the disclosure. In this embodiment, the system 100 includes a tomograph 110 and a computing device 120 coupled to the tomograph 110.

The tomograph 110 may be embodied using a device that is capable of performing a tomography operation on the to-be-inspected object 150. The tomograph 110 may include components that are configured to perform the tomography operation using X-ray, magnetic resonance imaging (MRI), optical projection, ultrasound, etc. Via the tomography operation, the tomograph 110 is able to generate a plurality of two-dimensional (2D) images related to the to-be-inspected object 150. Specifically, the 2D images show various sections of the to-be-inspected object 150, respectively. The 2D images may be referred to as tomograms.

In this embodiment, the to-be-inspected object 150 may be a fin field-effect transistor (FinFET), a semiconductor component, a metal material, a biomedical material, or other kinds of objects that may require inspection of structures embedded within.

The computing device 120 may be embodied using a server, a personal computer, a laptop, a tablet, a smartphone, or other devices having computational capabilities for performing the operations described below. In this embodiment, the computing device 120 may be a server device and includes a processor 122, a data storage 124 and a communication unit 126.

The processor 122 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The data storage 124 is coupled to the processor 122, and may be embodied using random access memory (RAM), read only memory (ROM), programmable ROM (PROM), firmware, flash memory, etc., or any combination thereof. The data storage 124 stores instructions that, when executed by the processor 122, cause the processor 122 to perform the operations as described below.

The communication unit 126 may include at least one of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) and/or fifth generation (5G) of wireless mobile telecommunications technology, and/or the like.

The tomograph 110 has a certain field of view (FoV). The system 100 may be configured to obtain a number of tomograms of the to-be-inspected object 150 and execute the method for constructing a three-dimensional (3D) model of the to-be-inspected object 150 based on the tomograms.

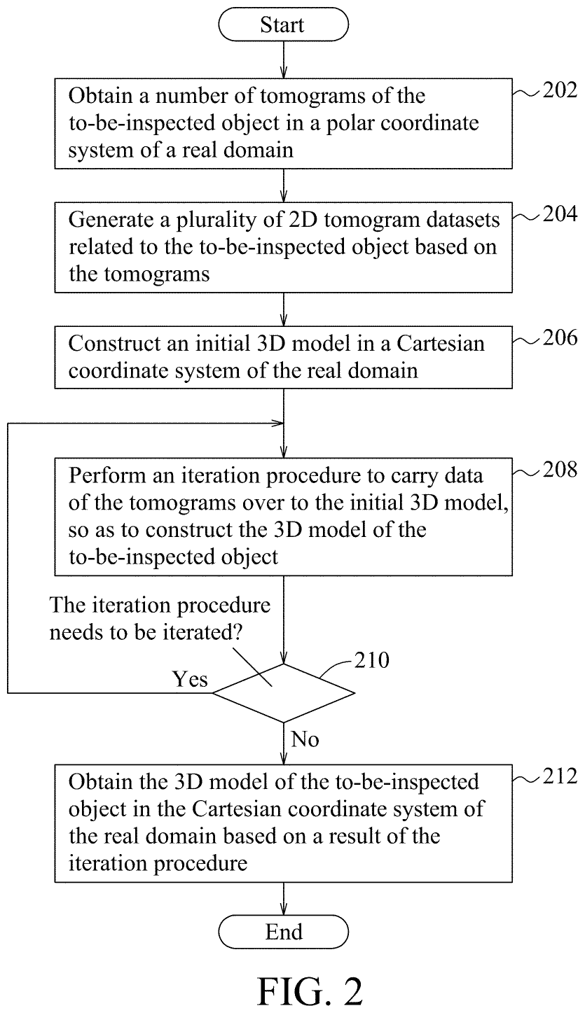

FIG. 2 is a flow chart illustrating steps of the method for constructing a 3D model of the to-be-inspected object 150 according to one embodiment of the disclosure. In this embodiment, the method is implemented using the system 100 as shown in FIG. 1.

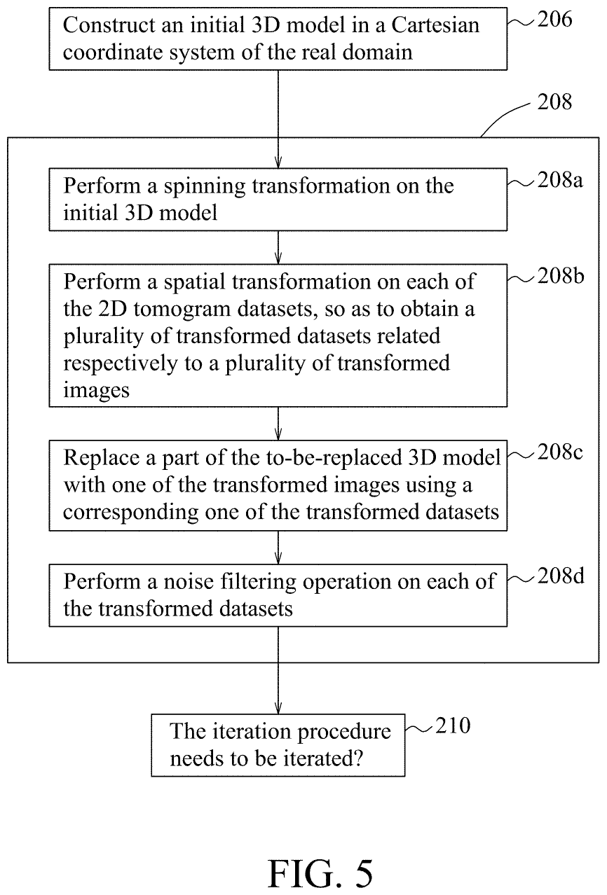

In step 202, the tomograph 110 is configured to obtain a number of tomograms of the to-be-inspected object 150 in a polar coordinate system of a real domain. In this embodiment, a plurality of tomograms are taken, and each of the tomograms is taken at a specific angular position with respect to an axis of the to-be-inspected object 150 (e.g., a central axis vertically passing through a center of the to-be-inspected object 150). FIG. 5 illustrates a number of exemplary tomograms (sixty-four in total) of the to-be-inspected object 150. Each of the tomograms may be taken at a specific and different angular position with respect to the axis of the to-be-inspected object 150.

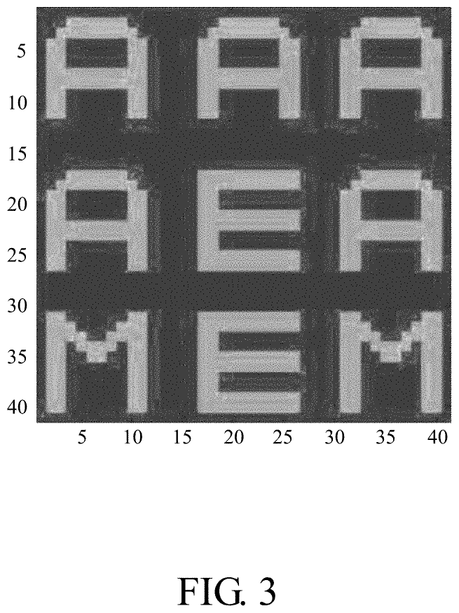

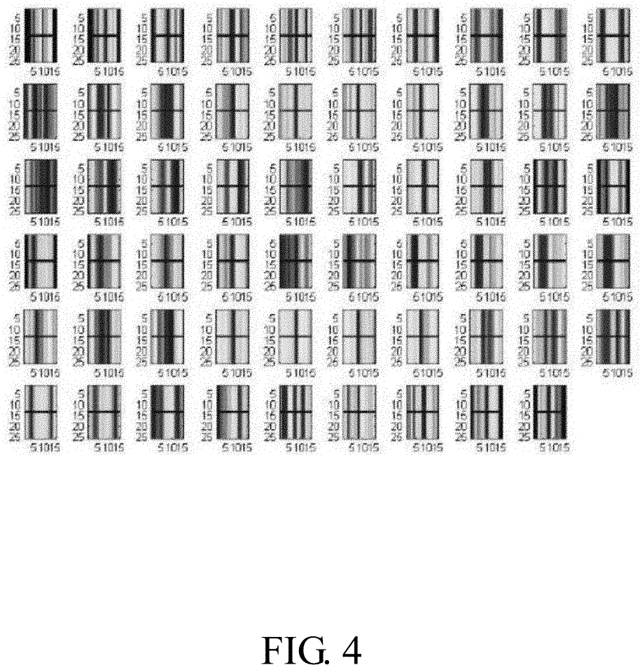

FIG. 3 is a front view of an example of the to-be-inspected object 150. The to-be-inspected object 150 shown in FIG. 3 includes a plurality of 3D structures each resembling an English character. In one embodiment, the to-be-inspected object 150 may include multiple 3D structures that are embedded therein; for example, a 3D structure may be a specific layer in a semiconductor wafer.

It is noted that the FoV of the tomograph 110 may be larger than one of the structures embedded in the to-be-inspected object 150, but smaller than a size of the to-be-inspected object 150. Moreover, only a part of the to-be-inspected object 150 may be of interest, such as the structure “E” shown in the middle of FIG. 3. As such, in step 202, the tomography operation may be done by placing the structure “E” at the center of the FoV of the tomograph 110, and the resulting tomograms may include not only information of the structure “E”, but also information of other structures surrounding or next to the structure “E”.

The tomograms may be obtained in one of various manners that are commercially available, and details thereof are omitted herein for the sake of brevity. Then, the tomograms are transmitted to the computing device 120.

In step 204, in response to receipt of the tomograms, the processor 122 of the computing device 120 is configured to generate a plurality of 2D tomogram datasets related to the to-be-inspected object 150 based on the tomograms. Each of the tomogram datasets is related to a respective one of the tomograms and includes data of the respective one of the tomograms that shows a part of the to-be-inspected object 150. The data of one of the tomograms includes, for each pixel of the tomogram, a pixel value and a coordinate set of the pixel in the polar coordinate system of the real domain. In the example of FIG. 5, sixty-four 2D tomogram datasets may be generated. Each of the 2D tomogram datasets may be expressed in a form of at least one matrix. Each of the at least one matrix includes a plurality of entries each having a value that may be used to represent pixel data of the to-be-inspected object 150. That is to say, the matrices are generated based on the tomograms, and the values of the entries of one of the matrices are pixel values of the corresponding one of the tomograms.

In step 206, the processor 122 constructs an initial three-dimensional (3D) model in a Cartesian coordinate system of the real domain. The initial 3D model may be expressed in the form of a matrix array that includes a number of matrices. Each of the matrices includes a plurality of entries each having a value that may be used to represent pixel data of a 3D object. It is noted that pixel data of the initial 3D model may include arbitrary values in the matrix array.

In step 208, the processor 122 performs an iteration procedure to carry data of the tomograms over to the initial 3D model, so as to construct the 3D model of the to-be-inspected object 150. It is noted that the purpose of performing the iteration procedure is to fit the data of the tomograms (i.e., the 2D tomogram datasets) into the initial 3D model, so as to construct the 3D model that accurately reflects the to-be-inspected object 150.

Specifically, FIG. 5 is a flowchart illustrating exemplary sub-steps of the iteration procedure according to one embodiment of the disclosure.

In sub-step 208a, the processor 122 performs a spinning transformation on the initial 3D model. The spinning transformation results in a to-be-replaced 3D model in a polar coordinate system of a 3D Fourier domain rotated by a spin angle with respect to the axis of the to-be-inspected object 150. It should be noted that the initial 3D model serves as the to-be-replaced 3D model in the first execution of sub-step 208a, and the to-be-replaced 3D model in subsequent iteration of sub-step 208a is the to-be-replaced 3D model obtained in the latest execution of sub-step 208a.

Specifically, the spinning transformation involves operations to “spin” the initial 3D model, originally in the Cartesian coordinate system, to the polar coordinate system by a specific spinning angle which is equal to the angular position of one of the tomograms.

The reason for conducting the spinning transformation is that the tomograms are taken in the polar coordinate system which is different from the Cartesian coordinate system of the initial 3D model, and in order to perform any operation between the initial 3D model and the tomograms, both the initial 3D model and the tomograms need to be expressed in a same coordinate system of a same domain. In addition, the method involves the initial 3D model being “spun” frequently and accurately in the polar coordinate system to correspond with the angular positions of the tomograms, and there is no feasible Fast Fourier transform between the Cartesian coordinate system and the polar coordinate system, so an efficient way to implement the spinning transformation is adopted in the disclosure to achieve the desired operations and is described in the following. Specifically, the operation of “transforming one point of the initial 3D model from the Cartesian coordinate system of the real domain to a point in the polar coordinate system of the Fourier domain” may be done using a plurality of geometric translation operations. In this embodiment, each of the geometric translation operations is a 2D Fast Fourier Transform (FFT) operation, which may be a sheared FFT operation.

It is noted that, in order to achieve the result of a conventional rotation operation of an original point by an angle (θ), a number of shift operations respectively in different directions may be adopted. The conventional rotation operation may be expressed in a form of a matrix operation as:

$$[ \begin{matrix}{x}^{′} \\ {y}^{′}\end{matrix} ] = [ \begin{matrix}cos θ & sin θ \\ - sin θ & cos θ\end{matrix} ] [ \begin{matrix}x \\ y\end{matrix} ]$$

where (x, y) represents the coordinates of the original point, and (x′, y′) represents the coordinates of a new point after the conventional rotation operation.

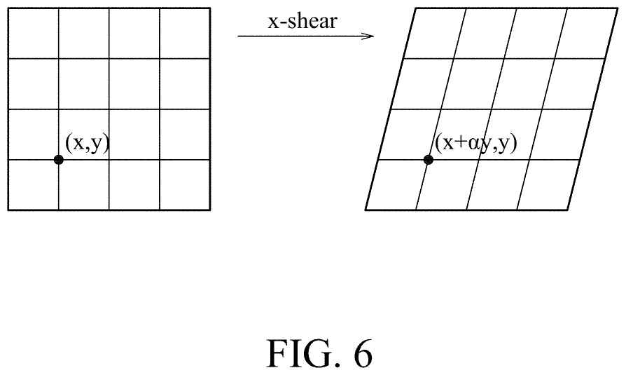

The shift operation of the original point (also known as a “shear” transformation) by a shear factor (α) in one direction may be expressed in a form of a matrix operation as:

$$[ \begin{matrix}{x}^{′} \\ {y}^{′}\end{matrix} ] = [ \begin{matrix}1 & α \\ 0 & 1\end{matrix} ] [ \begin{matrix}x \\ y\end{matrix} ]$$

where (x, y) represents the coordinates of the original point, and (x′, y′) represents the coordinates of a new point after the operation of the shear transformation. FIG. 6 illustrates an exemplary shear transformation with respect to a horizontal direction.

It is noted that the spinning transformation of sub-step 208a may be done with a number of shear transformations with respect to different directions. The corresponding operations may be expressed as

$$[ \begin{matrix}1 & α \\ 0 & 1\end{matrix} ] [ \begin{matrix}1 & 0 \\ β & 1\end{matrix} ] [ \begin{matrix}1 & γ \\ 0 & 1\end{matrix} ] = [ \begin{matrix}cos θ & sin θ \\ - sin θ & cos θ\end{matrix} ]$$

and the shear factors α,β and γ respectively for the shear transformations may be calculated as

$$α = γ = tan \frac{θ}{2} , β = sin θ .$$

As such, the operations of sub-step 208a may be done using three sheared FFT operations based on the above shear factors.

A spin operation as described above may be decomposed into three shear operations, each of which may be implemented in the Fourier domain by FFT. Specifically, each sheared FFT operation may be performed using a 2D extension of a one-dimensional (1D) Fourier shift theorem (i.e., 1D fractional Fourier transform).

In sub-step 208b, the processor 122 performs a spatial transformation on each of the 2D tomogram datasets, so as to obtain a plurality of transformed datasets that are obtained respectively from the 2D tomogram datasets and that are related respectively to a plurality of transformed images. The transformed images are in the polar coordinate system of the 3D Fourier domain and correspond with the tomograms, respectively.

It is noted that in this embodiment, the spatial transformation may be a 2D FFT operation. The purpose of sub-step 208b is to put the to-be-replaced 3D model and each of the transformed images in the same coordinate system (polar coordinate system) in the same domain (3D Fourier domain). Similar to the 2D tomogram datasets, each of the transformed datasets may be in a form of at least one matrix.

In sub-step 208c, the processor 122 is programmed to replace a part of the to-be-replaced 3D model with one of the transformed images in the polar coordinate system of the 3D Fourier domain using a corresponding one of the transformed datasets.

That is to say, after the to-be-replaced 3D model is spun in sub-step 208a to an angle that corresponds with an angle of one of the transformed images, the processor 122 may be configured to use the transformed dataset that corresponds with the one of the transformed images to directly replace a section of the to-be-replaced 3D model that passes through the axis and has an angular position equal to the angle of a corresponding one of the transformed images. In this manner, after each of the transformed images is used to replace various parts of the to-be-replaced 3D model, the resulting 3D model may be approximated to form the 3D model of the to-be-inspected object 150.

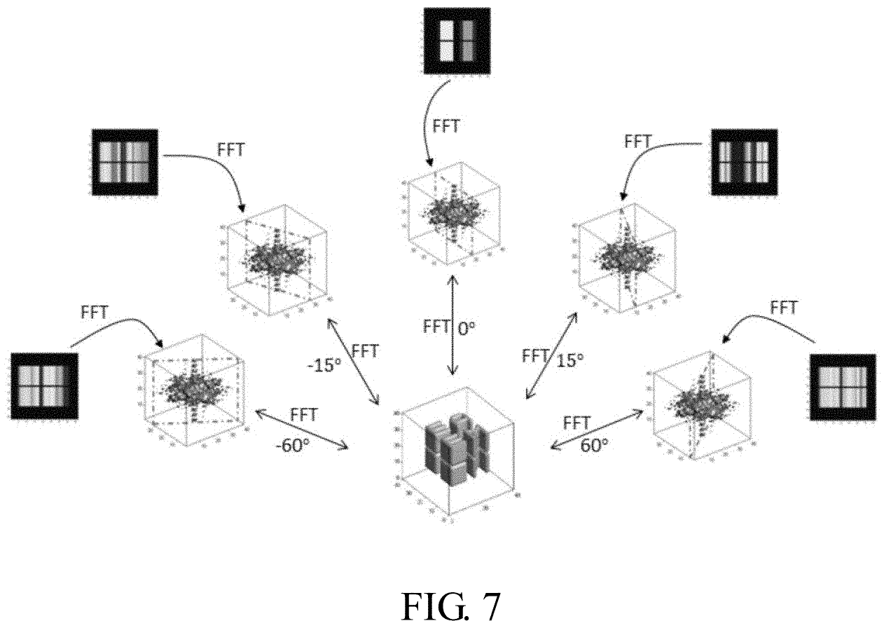

Further referring to FIG. 7, where five exemplary transformed images are present, each being at a specific angle. For each of the exemplary transformed images, the initial 3D model is subjected to a spinning transformation in sub-step 208a, and the transformed image is obtained in sub-step 208b via the spatial transformation and is used to replace a part of the to-be-replaced 3D model in sub-step 208c. That is to say, in the example of FIG. 5, sub-steps 208a to 208c are repeated five times until each of the transformed images has been used to replace part of the to-be-replaced 3D model. It is noted that in other embodiments, various numbers of tomograms may be obtained, and sub-steps 208a to 208c may be repeated to replace the to-be-replaced 3D model using all of the assemble images corresponding respectively to the tomograms.

Afterward, in sub-step 208d, the processor 122 performs a noise filtering operation on each of the transformed datasets.

Specifically, the processor 122 may be programmed to first perform an inverse spinning operation (i.e., a set of operations that achieve opposite effects of the spinning operations) on the to-be-replaced 3D model that has been replaced with the transformed images, so as to put the to-be-replaced 3D model back to the Cartesian coordinate system of the real domain, with a spinning angle of zero.

Afterward, the processor 122 determines whether any one of the transformed datasets includes values that are improbable for the to-be-replaced 3D model.

For example, each of the transformed datasets is in a form of at least one matrix, each of which includes a plurality of entries each having a value. In this embodiment, the processor 122 determines, for each of the plurality of entries, whether the entry has one of a negative value and an imaginary value (due to noises resulting from the above-mentioned operations). For any one of the plurality of entries, when it is determined that the entry has one of a negative value and an imaginary value, the processor 122 may be programmed to replace the value of the entry with a value of zero.

It is noted that in other embodiments, various ways of noise filtering may be implemented as well. For example, in one embodiment, the noise filtering operation includes the processor 122 first determining whether any one of the plurality of entries is related to a part of the to-be-inspected object 150.

When it is determined that one of the plurality of entries is associated with a part of the to-be-inspected object 150 and has a value that is not zero, the processor 122 replaces the value of the one of the plurality of entries with a value of zero.

At this stage, it is said that the iteration procedure has been completed once. The processor 122 may then determine, in step 210, whether the iteration procedure needs to be iterated based on whether a predetermined converging condition regarding the iteration procedure is satisfied. The predetermined converging condition may be that no substantive change (substantially no change) can be seen in the values of the entries in the transformed datasets between two executions or iterations of the iteration procedure.

When the predetermined converging condition is unsatisfied, the determination of step 210 is affirmative and the flow goes back to sub-step 208a to repeat the iteration procedure with respect to the to-be-replaced 3D model that has been processed in the last iteration of step 208. Otherwise, the flow proceeds to step 212, in which the processor 122 obtains the 3D model of the to-be-inspected object 150 in the Cartesian coordinate system of the real domain based on a result of the iteration procedure. Typically, in order to satisfy the predetermined converging condition, the iteration procedure may need to be performed around three hundred times. In other embodiments, a user may input a pre-determined number (e.g., 300), and in turn, the processor 122 executes the iteration procedure for that pre-determined number of times before obtaining the 3D model.

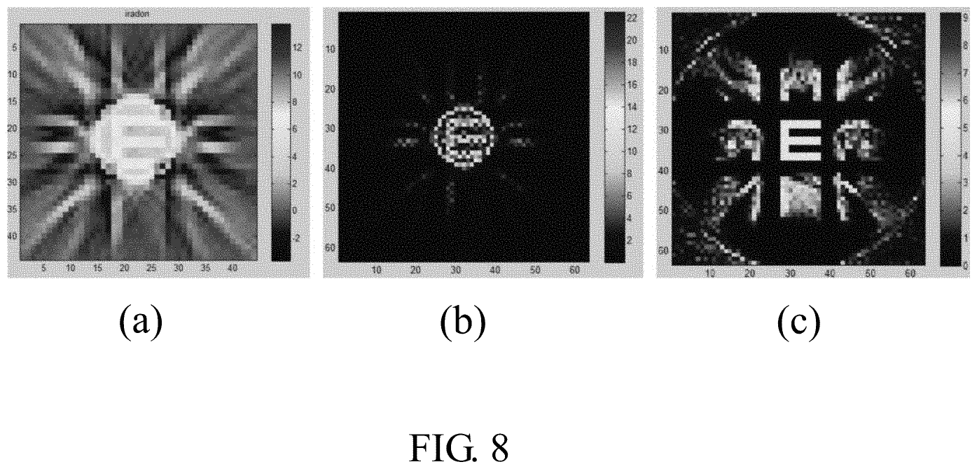

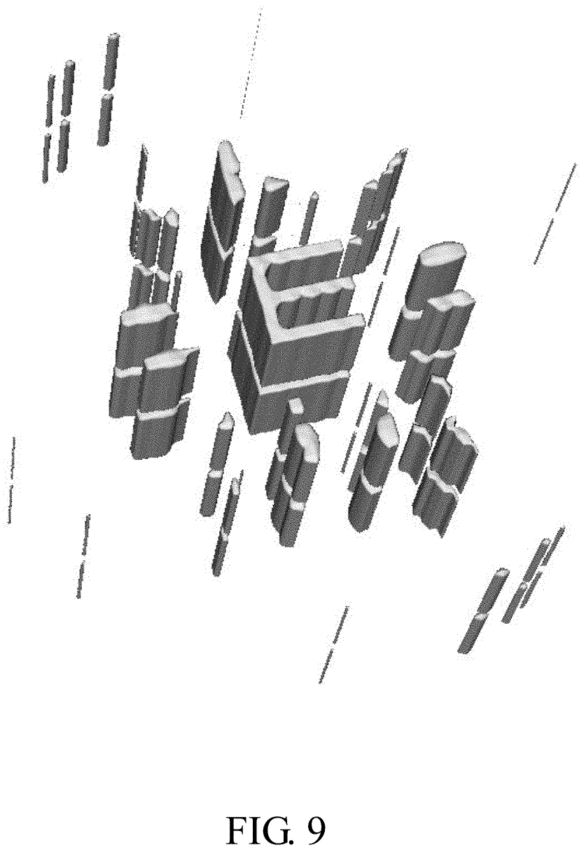

FIG. 8 illustrates an image of the resulting 3D model of the to-be-inspected object 150 that is focused on the structure “E” in the middle. It is noted that a resolution of the 3D model (see part (a) of FIG. 8) constructed using the method as described above is significantly higher than other 3D models constructed using conventional methods such as filtered back projection (FBP) (see part (b) of FIG. 8) and equally sloped tomography (EST) (see part (c) of FIG. 8). FIG. 9 is a schematic perspective view of a part of the 3D model of the to-be-inspected object.

To sum up, the embodiments of the disclosure provide a method for constructing a three-dimensional model of a to-be-inspected object. Due to the potentially large amount of computation needed to complete the task, the method includes a novel way to efficiently “spin” the to-be-replaced 3D model. By using the 2D FFT operation, a time complexity of the spinning transformation may be (N logN), while a time complexity of the spinning transformation is N² using the discrete Fourier transform. This greatly improves the efficiency of the operations in the iteration procedure, allowing the iteration procedure to be performed a large number of times to achieve a more desirable result without requiring a large amount of time and computational capacity.

It is noted that the method as described above is particularly useful in the case that only part of the to-be-inspected object 150 is of interest (e.g., the structure “E” in the middle of FIG. 3). Since the iteration procedure can be repeatedly performed at a higher efficiency, the construction of the 3D model of the part of interest may be more focused on the part of interest without the requirement to obtain tomograms of the entire to-be-inspected object 150, and therefore, the tomograms may be focused on the part of interest, allowing for a higher resolution for the obtained tomograms and the resulting 3D model.

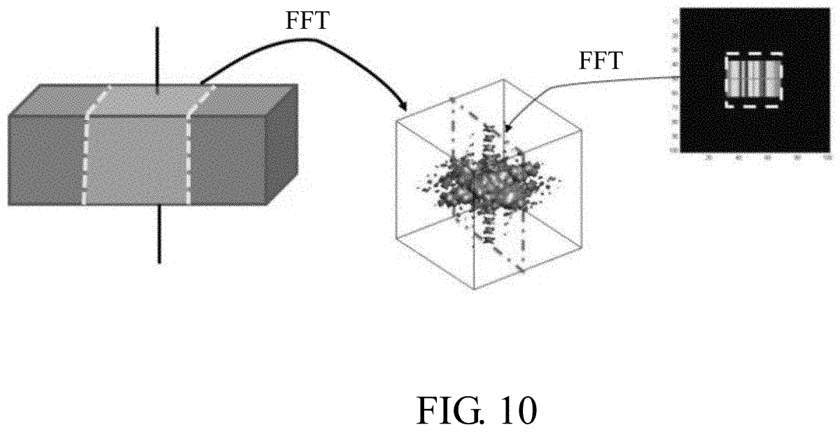

It is also noted that in some embodiments, the tomograms are all obtained to reflect a specific part inside the to-be-inspected object 150, where the to-be-inspected object 150 may have a size larger than the FoV of the tomograph 110, and none of the transformed images corresponds with the entirety of the to-be-inspected object 150. That is to say, it is not necessary to obtain tomograms that cover the entirety of the to-be-inspected object 150 in order to perform the operations as described above. In the example of FIG. 10, a part of the initial 3D model that corresponds with one of the tomograms may be selected, and the spinning transformation is performed with respect to said part of the initial 3D model.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for constructing a three-dimensional (3D) model of a to-be-inspected object, the method to be implemented using a system that includes a tomograph and a computing device, the method comprising steps of:
a) obtaining, by the tomograph, a plurality of tomograms associated with the to-be-inspected object, each of the tomograms being taken at a specific angular position with respect to an axis of the to-be-inspected object;
b) generating, by the computing device, a plurality of two-dimensional (2D) tomogram datasets related the to-be-inspected object based on the tomograms, each of the tomogram datasets being related to a respective one of the tomograms and including data of the respective one of the tomograms that shows a part of the to-be-inspected object in a polar coordinate system of a real domain;
c) constructing, by the processor, an initial 3D model in a Cartesian coordinate system of the real domain;
d) performing, by the processor, an iteration procedure that includes sub-steps of
d-1) performing a spinning transformation on the initial 3D model, so as to obtain a to-be-replaced 3D model in a polar coordinate system of a 3D Fourier domain rotated by a spin angle with respect to the axis of the to-be-inspected object,
d-2) performing a spatial transformation on each of the 2D tomogram datasets, so as to obtain a plurality of transformed datasets that are obtained respectively from the 2D tomogram datasets and that are related respectively to a plurality of transformed images, the transformed images being in the polar coordinate system of the 3D Fourier domain and corresponding with the tomograms, respectively,
d-3) replacing, by the processor, a part of the to-be-replaced 3D model with one of the transformed images in the polar coordinate system of the 3D Fourier domain using a corresponding one of the transformed datasets, and
d-4) repeating sub-steps d-1) to d-3) with the to-be-replaced 3D model obtained in a previous execution of sub-step d-3) serving as the initial 3D model to be processed in a current execution of sub-step d-1) until each of the transformed images has been used to replace the to-be-replaced 3D model; and
e) obtaining, by the processor, the 3D model of the to-be-inspected object in the Cartesian coordinate system of the real domain based on a result of the to-be-iterated procedure.

2. The method of claim 1, wherein sub-step d-1) includes performing three geometric translation operations to implement the spinning transformation.

3. The method of claim 2, wherein each of the geometric translation operations is a 2D Fast Fourier Transform (FFT) operation.

4. The method of claim 3, wherein the FFT operation is a sheared FFT operation.

5. The method of claim 1, wherein the iteration procedure further includes, after the replacing, a noise filtering operation on each of the transformed datasets.

6. The method of claim 5, wherein each of the transformed datasets is in a form of a matrix including a plurality of entries each having a value, and the noise filtering operation includes, for each of the plurality of entries:
determining whether the entry has one of a negative value and an imaginary value; and
when it is determined that the entry has one of a negative value and an imaginary value, replacing the value of the entry with a value of zero.

7. The method of claim 4, wherein each of the transformed datasets is in a form of a matrix including a plurality of entries each having a value, and the noise filtering operation includes:
determining whether any one of the plurality of entries is associated with a part of the to-be-inspected object; and
when it is determined that one of the plurality of entries is associated with a part of the to-be-inspected object and has a value that is not zero, replacing the value of the one of the plurality of entries with a value of zero.

8. The method of claim 1, wherein step d) is repeated prior to step e) until a predetermined converging condition regarding the iteration procedure is satisfied.

9. The method of claim 1, wherein:
the tomograms are obtained to reflect a specific part inside the to-be-inspected object, and none of the transformed images corresponds with an entirety of the to-be-inspected object; and
in sub-step d-1), the spinning transformation is performed with respect to one part of the initial 3D model that corresponds with one of the tomograms.
